(19) United States
(12) Patent Application Publication
(10) Pub. No.: US 2017/0221395 A1
(43) Pub. Date: Aug. 3, 2017

(54) PROPULSION UNIT ALLOWING THE DISPLAY OF A MESSAGE

(71) Applicant: PARROT DRONES, Paris (FR)

(72) Inventors: Yoni BENATAR, LES LILAS (FR); Alexis FOIRET, PARIS (FR)

(73) Assignee: PARROT DRONES, Paris (FR)

(21) Appl. No.: 15/423,916

(22) Filed: Feb. 3, 2017

(30) Foreign Application Priority Data
Feb. 3, 2016 (FR) 16 50839

(51) Int. Cl. G09F 21/10; G09F 13/22; G09F 13/00; B64C 39/02; B64D 27/24

(52) U.S. Cl. CPC G09F 21/10; B64C 39/024; B64D 27/24; G09F 13/005; G09F 13/22; B64C 2201/027; B64C 2201/108; B64C 2201/042

(57) ABSTRACT

A drone propulsion unit includes a propeller with a hub and a plurality of blades, an electric motor with a motor support, and a motor control device, wherein the electric motor includes a fixed part with a stator connected to the motor support and a mobile part with a rotor mobile about an axis of rotation for driving the propeller, the propeller includes a blade with a plurality of electroluminescent diodes and a diode control device, the motor includes a hollow central shaft, and the motor support includes a communication device adapted to communicate with a communication device integrated in the propeller, with the communication devices being positioned on either side of the hollow shaft.

### CROSS RELATED APPLICATIONS

This application claims priority to French patent application No. 16 50839 filed on Feb. 3, 2016.

### TECHNICAL FIELD

The disclosed technology relates generally to a propulsion unit. More specifically, the disclosed technology relates to propulsion units of drones.

### BACKGROUND

Drone with propulsion units may include rotary-wing drones of the quadricopter type or drones of the sailwing type that are provided with one or several propulsion units, each having a propeller driven by a proper motor. The AR.Drone 2.0 or the Bebop Drone of Parrot SA, Paris, France are rotary-wing drones of the quadricopter type, and the eBee of SenseFly SA, Swiss or the Disco of Parrot are drones of the sailwing type. They are equipped with a series of sensors (accelerometers, three-axis gyrometers, altimeter) and may include at least one camera.

The rotary-wing drones are provided with several propulsions units driven by respective motors and may be adapted to be controlled in a differentiated manner in order to pilot the drone with respect to attitude and speed.

While there are various propulsion units of a rotary-wing drone, which may each include a propeller driven by an electric motor via a system for reducing the generally very high speed of rotation of the motor, current drones do not allow evolution or the integrating new functionalities to a propulsion unit. As such, there is a need for drones that offer new functionality to the propulsion unit, such as the ability to convey information to the user or drone pilot.

### BRIEF SUMMARY OF EMBODIMENTS

According to various embodiments, disclosed are propellers of a drone intended to be assembled to an electric motor of the rotary cage brushless synchronous motor type. Such an exemplary electric motor may have a hollow central shaft that may include a hub and a plurality of blades.

In some embodiments, at least one blade of the propeller includes a plurality of electroluminescent diodes, such that the propeller may further include a diode control device for controlling the electroluminescent diodes and a propeller communication device positioned on the propeller hub so as to communicate with an electric motor communication device of an electric motor via the hollow shaft of the electric motor. The diode control device may be adapted to communicate with the propeller communication device in order to emit and/or receive commands.

Other embodiments may include the following:
the communication devices (propeller communication device/electric motor communication device) are an emitter and/or receiver device
the communication devices (propeller communication device/electric motor communication device) are an infrared emitter and/or infrared receiver device;
the propeller comprises a magnetic field sensor; and
the plurality of electroluminescent diodes is positioned over the propeller length.

Embodiments may also include an electric motor of the rotary-cage brushless synchronous motor type, having a motor support, a fixed part that includes a stator connected to the motor support, a mobile part that includes a rotor mobile about a central axis of rotation of the motor, and a motor control device.

The electric motor may include a hollow central shaft, a motor support that includes a communication device (also referred to as electric motor communication device) adapted to communicate with a communication device (also referred to as propeller communication device) integrated in a propeller assembled to the motor. These communication devices may be each positioned on one side of the hollow shaft of the motor, and a motor control device may be adapted to communicate with the electric motor communication device in order to emit and/or receive commands.

Additional embodiments of the drone may also include:
the electric motor includes at least one inductor arranged on the fixed part of the motor and at least one other inductor arranged on the mobile part of the motor to receive power adapted to supply the diode control device;
the communication devices (propeller communication device/electric motor communication device) are an emitter and/or receiver device;
the communication devices (propeller communication device/electric motor communication device) are an infrared emitter and/or infrared receiver device; and
the electric motor comprises an magnet arranged on the fixed part of the motor and the propeller comprises a magnetic field sensor, so as to detect the position of the propeller with respect to the fixed part of the motor.

Additionally, various embodiments of the drone may also include a propulsion unit that includes a propeller with a hub and a plurality of blades, and an electric motor of the rotary-cage brushless synchronous motor type having a motor support. The electric motor may have a fixed part that includes a stator connected to the motor support, and a mobile part that includes a rotor mobile about a central axis of rotation of the motor for driving the propeller and a motor control device.

Other embodiments may include at least one blade of the propeller with a plurality of electroluminescent diodes. The propeller may further include a device for controlling the electroluminescent diodes and a motor. The motor may include a hollow central shaft, a motor support with a communication device positioned on one side of the hollow shaft of the motor to communicate with a propeller communication device integrated in a propeller assembled to the motor via the hollow shaft of said motor, and a motor control device adapted to communicate with the motor communication device in order to emit and/or receive commands to and from the diode control device.

Further embodiments may also include:
the electric motor includes at least one inductor arranged on the fixed part of the motor and at least one other inductor arranged on the mobile part of the motor to receive power adapted to supply the diode control device;
the communication devices (propeller communication device/electric motor communication device) are an emitter and/or receiver device;
the communication devices (propeller communication device/electric motor communication device) are an infrared emitter and/or infrared receiver device; and
the electric motor includes an magnet arranged on the fixed part of the motor and the propeller comprises a magnetic field sensor, so as to detect the position of the propeller with respect to the fixed part of the motor.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a perspective view of a drone with four propulsion units according to one particular embodiment.

FIG. 2 illustrates a sectional view of the propulsion unit through an axial plane with the propeller fastened to the motor according to one particular embodiment.

FIG. 3 illustrates a result of the display made by the propulsion unit according to one particular embodiment.

FIG. 4 is a flow diagram depicting an electronic architecture of a propulsion unit of a drone according to one particular embodiment.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

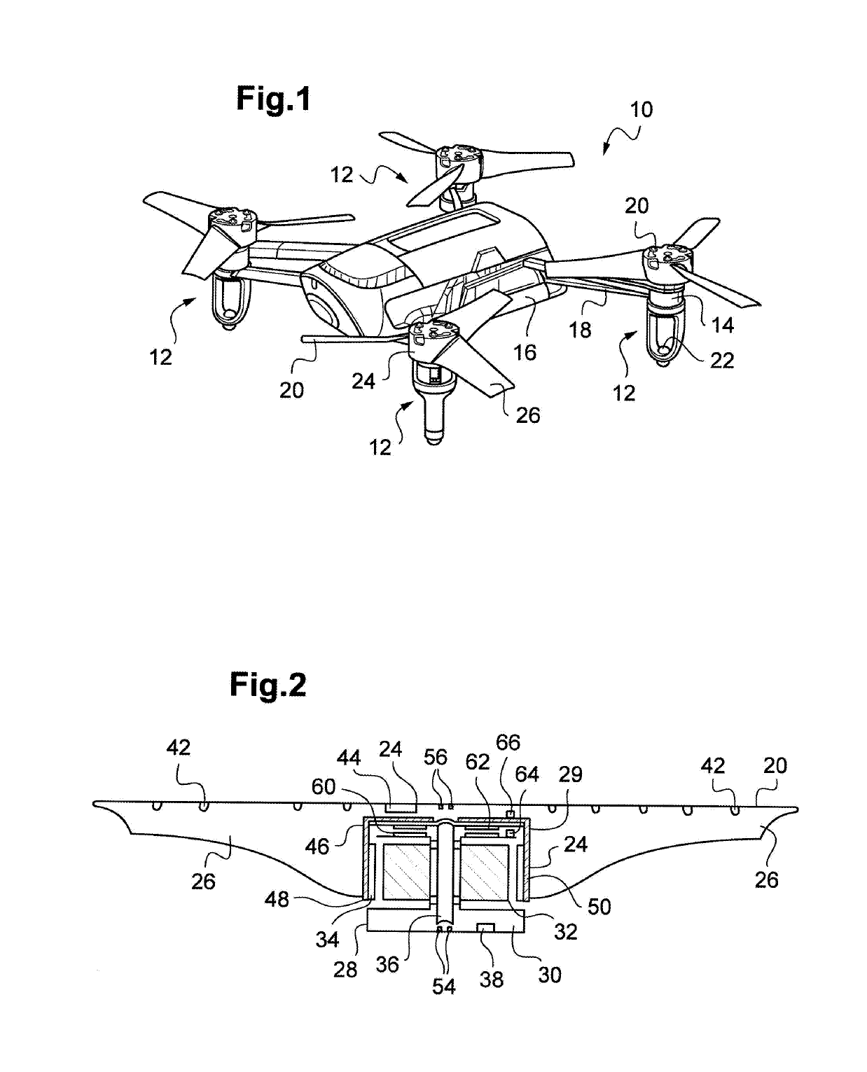

FIG. 1 illustrates a perspective view of a drone with four propulsion units according to one particular embodiment. As illustrated in FIG. 1, the drone 10 may be a quadricopter. By way of example only, such a quadricopter may be a Bebop Drone model of Parrot. Additionally, the drone 10 may also be a sailwing type, such as the eBee of SenseFly or the Disco of Parrot by way of further example only.

The drone 10 includes a drone body 16 with four propulsion units 12. The motors may be piloted independently by an integrated navigation and attitude control system. The drone body 16 may also include four linking arms 18 radiating from the drone body 16. Each arm is equipped at its distal end with a propulsion unit 12 that may include a motor driving a propeller 20 into rotation.

According to a particular embodiment, the propulsion unit 12 is extended by a drone body 16 with a support 22 to form a foot on which the drone 10 can rest on the ground when stopped.

In further embodiments, the propulsion unit 12 includes a propeller 20 having a hub 24 and a plurality of blades 26. By way of example only, the propulsion unit 12 includes at least two blades 26 and an electric motor 28 of the rotary-cage brushless synchronous motor type having a motor support 30.

The propulsion unit 12 may also include a hub 24. By way of example, the hub 24 comprises a flat disc-shaped upper wall, extended at its periphery with a cylindrical external wall carrying the blades 26.

FIG. 2 illustrates a sectional view of the propulsion unit through an axial plane with the propeller 20 fastened to the motor 28 according to one particular embodiment. As illustrated in FIG. 2, at least one blade 26 of the propeller 20 includes a plurality of electroluminescent diodes 42 and the propeller 20 includes a device 44 (also referred to as diode control devices) for controlling the electroluminescent diodes 42 to control the lighting of each of the electroluminescent diodes 42 and the colour of each of the electroluminescent diodes 42. For that purpose, the electroluminescent diodes 42 may be polychromatic or monochromatic electroluminescent diodes 42.

The motor 28 may include a fixed part 30 forming a support, which may allow it to be fastened to the linking arm 18 of the drone body 16 and a mobile part.

The fixed part 30 of the motor 28 may include a plurality of fixed windings wound on respective mandrels, where these windings are wound about an axis oriented radially with respect to the axis of rotation of the motor 28 and constituting the different elements of the stator 32 of the motor 28 to allow the creation of a rotating field between the different windings.

The mobile part of the motor 28 may include the rotor 34 fixed in particular to a rotary cage 46, to which the propeller 20 will be fastened for direct driving of the latter.

In some embodiments, the rotary cage 46 includes a cylindrical lateral skirt 48, where its external diameter is equal to the internal diameter of the cylindrical wall 50 of the propeller hub 24, so as to be able to fit this hub 24 to the rotary cage 46 with a very slight clearance. This may allow the propeller 20 to rotate about the rotary cage 43 at the time of mounting/dismounting the propeller 20 on the motor 28. The rotary cage 46 may be mounted on a mobile central shaft 36 of rotation of the motor 28.

The lateral skirt 48 carries, on the internal side, the magnetic elements that may include a rotor 34 intended to be driven by the rotating field created by the windings 32 arranged opposite to each other. By way of example, the magnetic elements may be permanent magnets.

In some embodiments, the central shaft 36 is a hollow shaft. The fixed part 30 of the motor 28 may form a motor support that may include a communication device 54 (also referred to as electric motor communication device). Additionally, the propeller 20 may also include a communication device 56 (also referred to as propeller communication device) integrated onto the propeller 20. The communication devices 54, 56 may be positioned on either side of the hollow central shaft 36 of rotation of the motor 28. The communication devices 54, 56 may be adapted to be communicated by using the hollow part of the central shaft 36 of the motor 28.

According to an embodiment, the hub 24 of the propeller 20 may include a wall integrating the communication device 56, so that when the hub 24 is fixed to the motor 28, the communication device 56 is positioned above the hollow part of the central shaft 36 of the motor 28.

Likewise, the motor support 30 may include, for example, a communication device 54 positioned such that, at the time of assembling of the motor central shaft 36, the communication device 54 is positioned at the surface level of the hollow part of the motor central shaft 36.

The motor 28 may also include a stator 32 connected to the motor support 30 and a rotor 34 mobile about a central axis of rotation of the motor 28 for driving the propeller 20 and a motor control device 38. The motor control device 38 allows for controlling and monitoring the speed of the motor 28. The motor 28 may also include a central shaft 36, where the central shaft 36 may be an exemplary shaft mobile in rotation. Additionally, the motor 28 of each propulsion unit drives into rotation a respective propeller 20 extending in an approximately horizontal plane above the arm 18.

In order to pilot and control the display of a message by the propulsion unit, the motor control device 38 may be adapted to communicate with the communication device 54 of the motor 28. The communication device 54 of the motor 28 may emit commands to the diode control device 44 via the communication device 56 to receive and/or emit commands from the diode control device 44. For example, the motor control device 38 pilots the display of the message made on the propeller 20 by sending commands to the diode control device 44 to create the desired message to be displayed.

According to a particular embodiment, the communication devices 54, 56 are emitter and/or receiver devices. In other embodiments, communication devices 54, 56 may be infrared emitter and/or infrared receiver devices. The bidirectional communication of the communication devices 54, 56 allows:
sending commands and the updating of the software of the diode control device 44 by the motor control device 38 to the diode control device 44; and
receiving commands by the motor control device 38 information, such as information about the operation status of the diode control device 44.

According to an embodiment, the diode control device 44 and the communication device 56 of the propeller 20 may be over-molded so as to be protected from shocks and humidity and to allow good aerodynamic performances.

The command emitted by the diode control device 44 to each of the electroluminescent diodes 42 integrated to the propeller 20 allows for the controlled lighting for each of the electroluminescent diodes 42, as well as the desired colors of each of the electroluminescent diodes 42. The retinal persistence of the eye allows viewing the message emitted by the propeller when the propeller is in movement.

In order to transmit the power required for the electroluminescent diode control device 44 to operate, a mechanism for transmitting this necessary power from the motor 28 to the propeller 20 must be inserted. According to a particular embodiment, the electric motor 28 may include at least one inductor 60 arranged on the fixed part of the motor and at least one inductor 62 arranged on the mobile part of the motor 28 to receive the power that is later transmitted to the propeller 20. By way of example, an electric cable may be used to operate the diode control device 44.

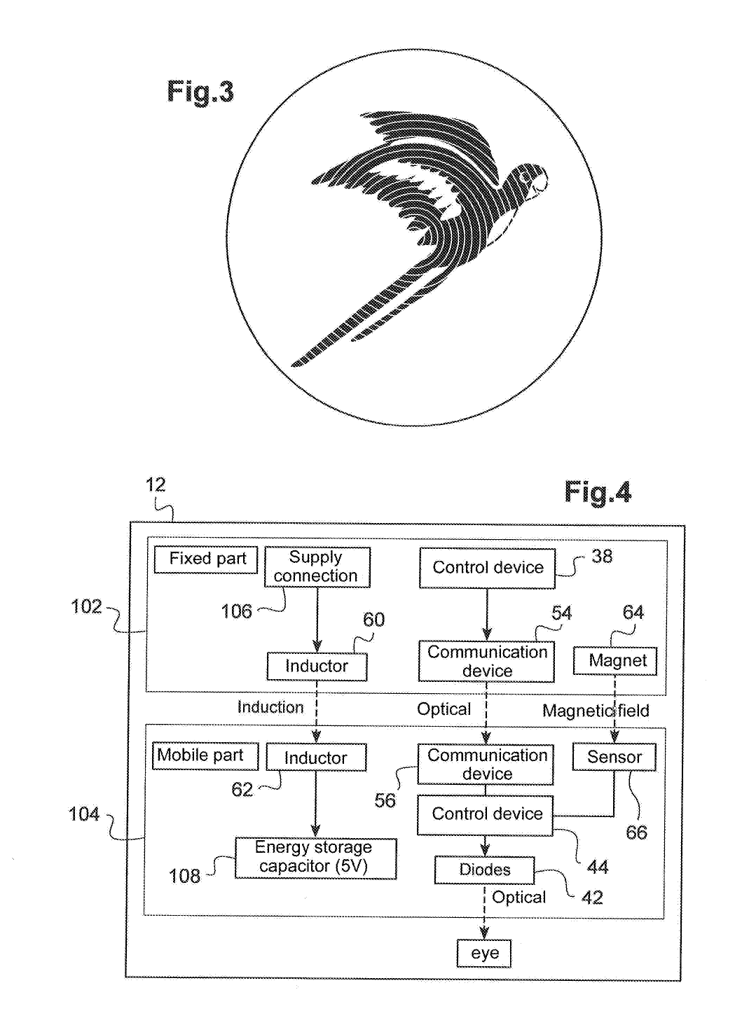

FIG. 3 illustrates a result of a display made by the propulsion unit according to one particular embodiment. To make such a display, the plurality of electroluminescent diodes is positioned over the length of the blade, in the radial direction of the blade. The display via the propeller electroluminescent diodes allows displaying a text message, an image, a video, or a logo as shown in FIG. 3. By way of further example, the display may be in color.

Preferably, in order to obtain a retinal persistence without flicker, it is necessary that the complete image is displayed at more than 30 Hz. That way, the displayed image is correct when the rotational speed of the propeller reaches about 1800 rotations per minute.

FIG. 4 is a flow diagram depicting an electronic architecture of a propulsion unit 12 of a drone according to one particular embodiment. As illustrated, an inductor 60 is arranged on the fixed part 102 of the motor and at least one inductor 62 arranged on the mobile part 104 of the motor to receive the power that is later transmitted to the propeller. Furthermore, in order to synchronize the propeller and the fixed part 102 of the motor, a magnet 64 may be inserted onto the fixed part 102 of the motor. Additionally, a magnetic field sensor 66, for example a Hall effect sensor, may also be inserted into the propeller, so as to detect the position of the propeller with respect to the fixed part 102 of the motor.

According to a particular aspect, the propeller may include a way for connecting the diode control device 44, the communication devices 54, 56 (electric motor communication device, propeller communication device), the electroluminescent diodes 42 and the magnetic field sensor 66. By way of example, such connections may be formed by an over-molded flexible conductor or a printed circuit board (PCB), such as a rigid printed circuit.

The fixed part 102 of the propulsion unit 12 may include a supply connection means 106, where this connection means is connected in particular to the inductor 60 arranged on the fixed part 102 of the motor 28, so as to supply the inductor 62. The fixed part 102 of the propulsion unit 12 may also include a motor control device 38, such as a microcontroller. The motor control device 38 may be connected at least the motor communication device 54. Additionally, the fixed part 102 of the propulsion unit 12 comprises a magnet 64.

The mobile part 104 of the propulsion unit 12 may include the rotor part of the motor, which may be assembled to the propeller. The inductor 62 may be adapted to be electrically connected to a rectifier and to an energy accumulator 108. By way of example, the capacitor, the rectifier, and the energy accumulator may be mounted on the propeller.

The propeller may include communication device 56 connected to the diode control device 44 which may include a microcontroller, and the latter piloting the electroluminescent diodes 42 positioned on at least one blade of the propeller. The energy accumulator 108 may also supply the propeller diode control device 44.

Finally, the mobile part 104 of the propulsion unit 12 comprises a magnetic field sensor 66, for example a Hall effect sensor positioned on the propeller and communicating with the propeller diode control device 44.

The communication devices 54 and 56 of the fixed part 102 and the mobile part 104, respectively, of the propulsion unit 12 will communicate by optical link. By way of example only, such communication may be by infrared.

Finally, the magnet 64 positioned on the fixed part 102 of the motor unit will emit a magnetic field that will be detected by the magnetic field sensor 66 positioned on the mobile part 104 of the motor unit. Hence, it clearly appears from this figure that the fixed part 102 and mobile part 104 of the propulsion unit 12 are coupled without any physical link as regards the power transmission.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A propeller comprising:
a plurality of blades with two or more electroluminescent diodes placed on a surface of at least one blade;
wherein the plurality of blades is assembled onto an electric motor comprising a hollow central shaft and a propeller hub;
a propeller communication device positioned on the propeller hub to communicate with an electric motor communication device via the hollow shaft of the electric motor; and
a diode control device that communicates with the propeller communication device in order to emit and receive commands for controlling the electroluminescent diodes.

2. The propeller of claim 1, wherein the propeller communication device and the electric motor communication device each comprise an emitter device or a receiver device.

3. The propeller of claim 1, wherein the propeller communication device and the electric motor communication device each comprise an infrared emitter device or an infrared receiver device.

4. The propeller of claim 1, wherein the propeller comprises a magnetic field sensor.

5. The propeller of claim 1, wherein the two or more electroluminescent diodes are positioned over a length of the propeller.

6. An electric motor assembly comprising:
an electric motor comprising a hollow central shaft;
a mobile portion of the electric motor comprising a rotor rotating around a central axis of the electric motor;
a fixed portion of the electric motor comprising a stator connected to a motor support, the motor support comprising an electric motor communication device positioned on a first side of the hollow central shaft; and
wherein the motor support communicates with the propeller communication device located on a propeller assembled on a second side of the hollow central shaft of the motor;
a motor control device in communication with the electric motor communication device in order to emit and receive commands.

7. The electric motor assembly of claim 6, wherein the electric motor comprises at least a first inductor arranged on the fixed portion of the electric motor and a second inductor arranged on the mobile portion of the electric motor to receive power.

8. The electric motor assembly of claim 6, wherein the propeller communication device and the electric motor communication device comprise an emitter device or a receiver device.

9. The electric motor assembly of claim 6, wherein the propeller communication device and the electric motor communication device comprise an infrared emitter device or an infrared receiver device.

10. The electric motor assembly of claim 6, wherein the electric motor comprises a magnet arranged on the fixed portion of the electric motor.

11. A drone propulsion device comprising:
a propeller comprising a propeller hub and a plurality of blades with at least one blade comprising a plurality of electroluminescent diodes;
an electric motor comprising a rotary-cage brushless synchronous motor with a motor support and a hollow central shaft; and
wherein the electric motor has a fixed portion comprising a stator connected to the motor support and a mobile portion comprising a rotor rotating around a central axis of the electric motor for driving the propeller and a motor control device;
wherein the motor support comprises an electric motor communication device located on a first side of the hollow central shaft to communicate with a propeller communication device located on a second side of the hollow central shaft;
a motor control device in communication with the electric motor communication device in order to emit and receive commands from the diode control device.

12. The drone propulsion device of claim 11, wherein the electric motor comprises at least a first inductor arranged on the fixed portion of the motor and at least a second inductor arranged on the mobile portion of the motor to receive power supplied to the diode control device.

13. The drone propulsion device of claim 11, wherein the propeller communication device and the electric motor communication device comprise an emitter device and a receiver device.

14. The drone propulsion device of claim 11, wherein the propeller communication device and the electric motor communication device comprise an infrared emitter device and an infrared receiver device.

15. The drone propulsion device of claim 11, wherein the electric motor comprises a magnet positioned on the fixed portion of the motor and the propeller comprises a magnetic field sensor to detect the position of the propeller with respect to the fixed portion of the motor.

16. A drone comprising:
a body; and
a propelling unit comprising:
a propeller comprising a propeller hub and a plurality of blades with at least one blade comprising a plurality of electroluminescent diodes;
an electric motor comprising a rotary-cage brushless synchronous motor with a motor support and a hollow central shaft; and
wherein the electric motor has a fixed portion comprising a stator connected to the motor support and a mobile portion comprising a rotor rotating device;
wherein the motor support comprises an electric motor communication device located on a first side of the hollow central shaft to communicate with a propeller communication device located on a second side of the hollow central shaft;
a motor control device in communication with the electric motor communication device in order to emit and receive commands from the diode control device.
